(19) United States
(12) Patent Application Publication
(10) Pub. No.: US 2011/0255308 A1
(43) Pub. Date: Oct. 20, 2011

(54) SYSTEM, MODULE, AND METHOD FOR CONSTANT CURRENT CONTROLLING OF POWER CONVERTER

(75) Inventors: Chun-Kong Chan, Hsin Chuang City (TW); Kuo-Jen Hsieh, Hsin Chuang City (TW)

(73) Assignee: LIEN CHANG ELECTRONIC ENTERPRISE CO., LTD.

(21) Appl. No.: 12/760,271

(22) Filed: Apr. 14, 2010

(51) Int. Cl. H02M 3/335

(52) U.S. Cl. 363/21.12

(57) ABSTRACT

A system, a module, and a method for constant current controlling of a power converter are disclosed. The constant current controlling system includes a power converter and a constant current controlling module. The power converter has a transformer and a switching unit. The switch unit is coupled with the primary coil of the transformer. The constant current controlling module is coupled with the transformer and the switching unit, for generating a discharge time and detecting a current waveform signal, before generating a control signal in order to adjust the duration of the switching period of the switching unit to ensure that an output current of the power converter may remain substantially the same.

### BACKGROUND OF THE INVENTION

1. Field of the Invention

The present invention relates to a system, a module, and a method for constant current controlling of a power converter, and more particularly, to system, module, and method for constant current controlling of a power converter according to signals obtained from a primary side of the power converter.

2. Description of the Related Art

Generally, the power converter may operate in a constant current (CC) mode and a constant voltage (CV) mode. Please refer to FIG. 1, which is a conventional circuit diagram of a power converter. The power converter receives an input voltage Vi for generating an output voltage Vo. And the power converter has a transformer 11, a control IC 13, an optical coupler 15, and an operational amplifier 17 and 19.

When a switching unit (which is embedded in the control IC 13) is turned on, the input current flows through the transformer 11, and the switching unit before reaching to the ground. And when the switching unit is turned off, a current waveform signal Ip=(Vi*ΔT)/Lp is at the primary side of the transformer 11. As such, an energy equals to 0.5*Lp*Ip² where “Vi” stands for the input voltage, “Lp” stands for the inductance at the primary side of the transformer 11, and “ΔT” stands for the turn-on time of the switching unit.

As described above, the energy per second at the primary side of the transformer 11 is 0.5*Lp*Ip²*f, in which “f” stands for an operating frequency of the switching unit. And the energy per second at the primary side must equal to the output energy at the secondary side of the transformer 11. In other words, 0.5*Lp*Ip²*f must equal to Io*Vo.

For conventional CV controlling, the operational amplifier 17 is provided at the secondary side of the transformer 11, for detecting the value of the output voltage Vo. If the value of the output voltage Vo is too high, the operational amplifier sends a signal back to the control IC 13 through optical coupler 15. And the control IC 13 then regulates the operating frequency f or the current waveform signal Ip at the primary side of the transformer 11. And because the current waveform signal Ip corresponds to the turn-on time of the switching unit, the control IC 13 can regulate the current waveform signal Ip by changing the turn-on time of the switching unit. Therefore, the control IC 13 can regulate the output voltage Vo by changing either the operating frequency f or a duty cycle of the switching unit.

For some specific purposes, the output current Io must not exceed a particular value. The conventional controlling method may add a current sensor 18 at the secondary side of the transformer 11. And when the output current Io flows through the current sensor 18, the operational amplifier 19 will receive a voltage value indicative of the value of the output current Io. According to the voltage value, the operational amplifier then sends a signal to control IC 13 for controlling the duty cycle of the switching unit in order to ensure a delivery of a constant output current.

To sum up, when the output current Io is less than the particular value, the power converter operates in the CV mode while operating in the CC mode when the output current exceeds the particular value.

However, the conventional CC and CV controlling methods need at least two operational amplifiers 17 and 19, the current sensor 18, and the optical coupler 15, complicating the circuitry of the power converter and increasing the manufacturing cost and the size of the power converter.

### SUMMARY OF THE INVENTION

Because of the aforementioned problems, the present invention provides a constant current controlling system and method for a power converter. The present invention controls an output current of the power converter according to signals obtained from the primary side of the power converter. By utilizing the signals from the primary side, the power converter according to the present invention may not require the operational amplifiers, the current sensor, and the optical coupler at the secondary side.

The system of the present invention includes a power converter and a constant current controlling module. The power converter has a transformer and a switching unit coupled with a primary coil of the transformer. The constant current controlling module is coupled with the transformer and the switching unit, for generating information of a discharge time and receiving a current waveform signal from the primary side of the transformer. And, the constant current controlling module generates a control signal to adjust a duration of a switching period of the switching unit according to the information of the discharge time and the current waveform signal.

The constant current control module includes a peak current value fixing unit, a discharge time detection unit, and a switching period regulation unit. The peak current value fixing unit is coupled with the transformer and the switching unit, for obtaining the current waveform signal from the primary side of the transformer, and staying a peak current value of the current waveform signal flowing through the primary coil of the transformer at a first predetermined value. When the current waveform signal reaches the first predetermined value, the peak current value fixing unit then generates the control signal for turning off the switching unit.

The discharge time detection unit is coupled with the transformer, for generating the information of the discharge time according to a voltage waveform signal captured by an auxiliary coil winded at the primary side of the transformer.

The switching period regulation unit is coupled with the switching unit, for adjusting the duration of the switching period of the switching unit according to the information of the discharge time.

For further understanding of the invention, reference is made to the following detailed description illustrating the embodiments and examples of the invention. The description is only for illustrating the invention, not for limiting the scope of the claim.

### BRIEF DESCRIPTION OF THE DRAWINGS

The drawings included herein provide further understanding of the invention. A brief introduction of the drawings is as follows:

FIG. 1 is a circuit diagram of the conventional power converter;

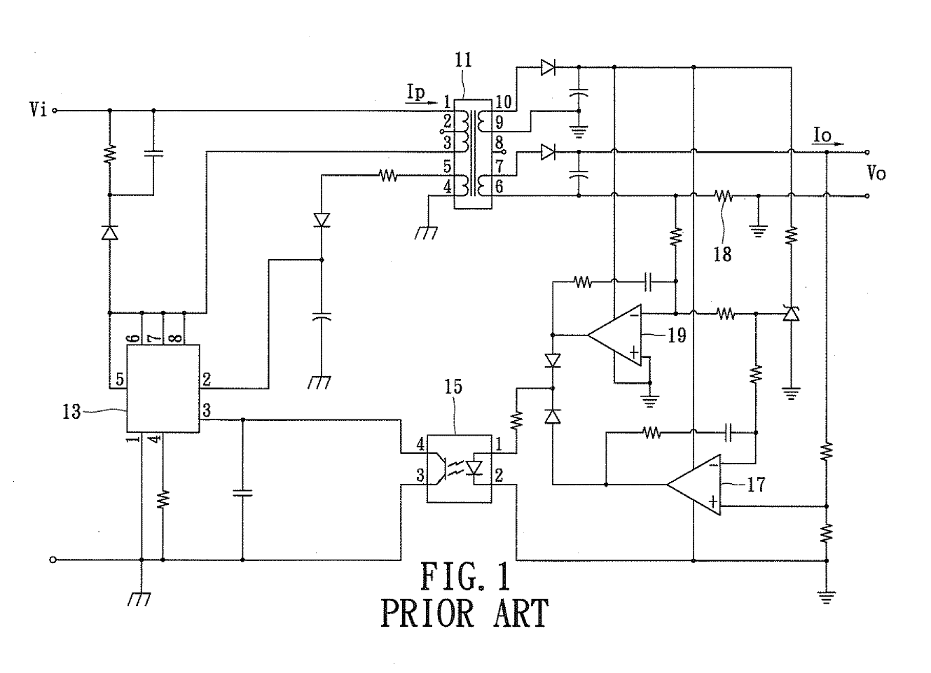

FIG. 2 is a circuit diagram of the constant current controlling system according to one embodiment of the present invention;

FIG. 3 is a circuit diagram of the constant current controlling system according to another embodiment of the present invention;

FIG. 4 is a schematic waveform diagram of the constant current controlling system according to one embodiment of the present invention; and

FIG. 5 is a flow chart of the constant current controlling method according to one embodiment of the present invention.

### DETAILED DESCRIPTION OF THE PREFERRED EMBODIMENTS

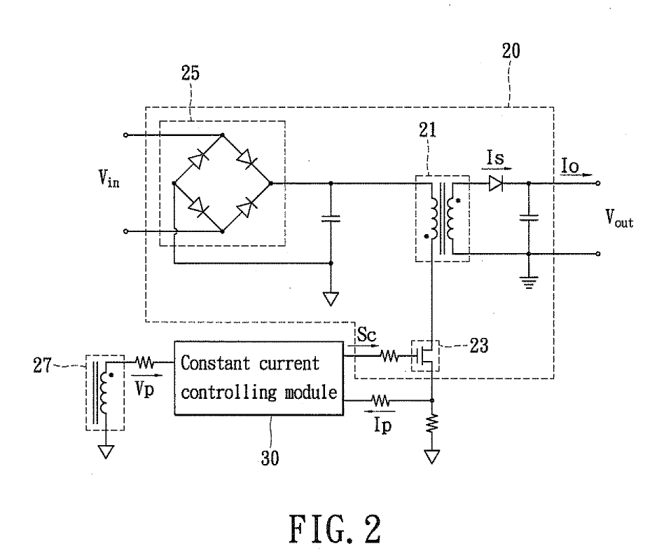

Please refer to FIG. 2, which is a circuit diagram of the constant current controlling system according to one embodiment of the present invention. The system includes a power converter 20, an auxiliary coil 27, and a constant current controlling module 30. In one implementation, the power converter 20 is a fly-back power converter.

The power converter 20 receives an input voltage Vin and generates an output voltage Vout to a load (not shown). The power converter 20 has a transformer 21, a switching unit 23, and a rectifier 25. The input voltage Vin would be converted into direct-current (DC) voltage by the rectifier 25 and a voltage level of the input voltage Vin would be regulated by the transformer 21, before the output voltage Vout is generated. The switching unit 23 is coupled with a primary coil of the transformer 21. The constant current controlling module 30 is configured to turn the switching unit 23 on or off in order to ensure that an output current Io would stay at a same current level.

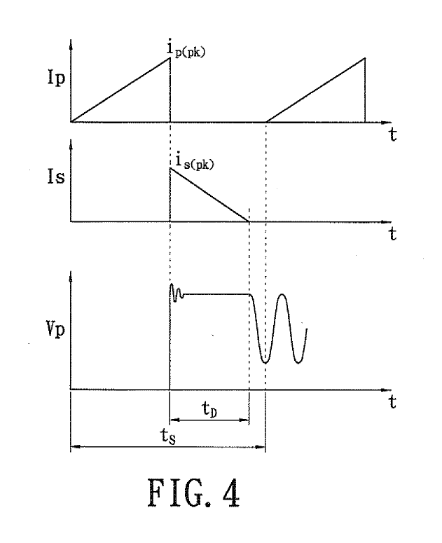

And please refer to FIG. 4, which is a schematic waveform diagram of the constant current controlling system according to one embodiment of the present invention. It is worth noting that an outputted energy at a secondary side of the transformer 21 equals to the area under a secondary current Is, which is 0.5*iₛ₍ₚₖ₎*t_{D} wherein iₛ₍ₚₖ₎ is a peak current value of the secondary current Is, and t_{D} is a discharge time of the secondary current Is. And, the outputted energy at the secondary side may equal to the averaged output current Io multiplied by a switching period t_{S} of the switching unit 23. As such, an equation is obtained in the follows:

Io=(0.5*iₛ₍ₚₖ₎*t_{D})/tₛ (1)

And under constant current (CC) mode, because of the changes of output voltage Vout the discharge time t_{D} of the secondary current Is varies. The slope of the discharging secondary current is −Vout/L_{T}, in which the L_{T} is the inductance of the transformer 21. According to (1), if the output current Io needs to remain the same while the discharge time t_{D} varies, the peak current value iₛ₍ₚₖ₎ and the switching period t_{S} may need to be regulated according to the variation of the discharge time t_{D}.

Specifically, in this embodiment, a particular ratio is between the secondary current Is and the current waveform signal Ip, in which the particular ratio is a ratio of a winding. So, by causing a peak current value iₚ₍ₚₖ₎ of the current waveform signal Ip at the primary side of the transformer 21 to stay at a first predetermined value the constant current controlling module 30 may cause the peak current value iₛ₍ₚₖ₎ of the secondary current Is to stay at a second predetermined value. Once the peak current value iₛ₍ₚₖ₎ of the secondary current Is remains at the second predetermined value, to maintain the output current Io at the same current level when the discharge time tₒ varies the constant current controlling module 30 may adjust the duration of the switching period t_{S} by tracking a variation of the discharge time t_{D}. For example, if the discharge time t_{D}′ has been 1.2 times larger than the original discharge time t_{D}, the switching period t_{S} may be adjusted to be 1.2 times larger than its original value.

Please refer to FIG. 2 again, in this embodiment, the auxiliary coil 27 is provided to the primary side of the transformer 21 for capturing a voltage waveform signal Vp at the primary side, which is shown in FIG. 4. The voltage waveform signal Vp at the primary side is sent to the constant current controlling module 30.

The voltage waveform signal Vp may correspond to the discharge time t_{D} of the secondary current Is. More specifically, as shown in FIG. 4, the length of the duration during which the voltage waveform signal Vp stays at a peak value thereof may correspond to a respective discharge time t_{D} of the secondary current Is. Thus, the constant current controlling module 30 may receive the information of the discharge time t_{D} on basis of the received voltage waveform signal Vp.

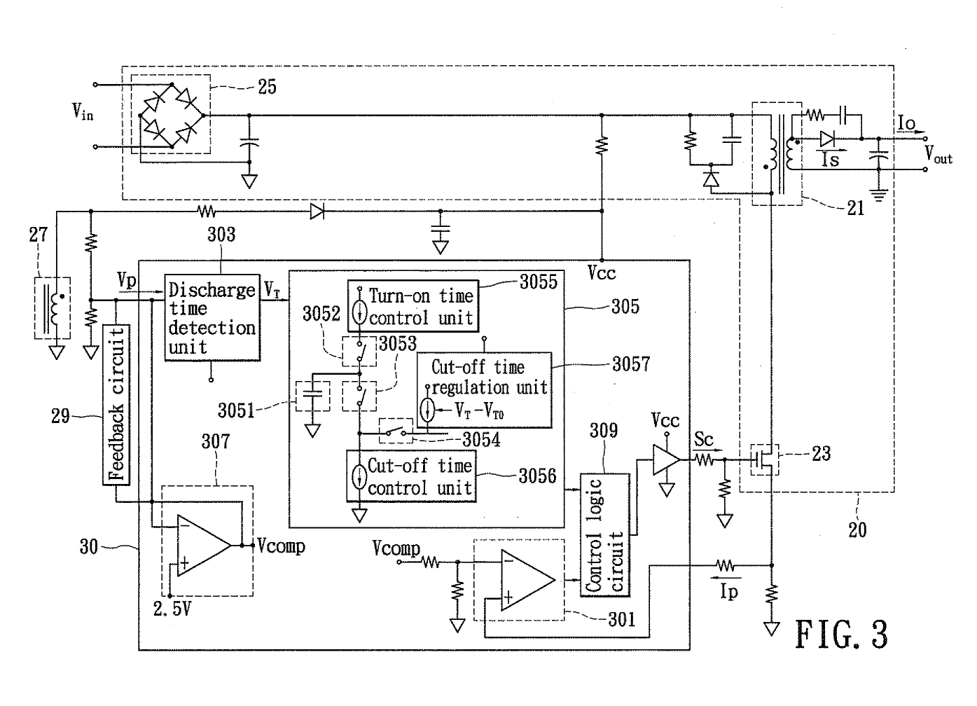

In conjunction with FIG. 4, FIG. 3 is a schematic diagram of the constant current controlling system according to one embodiment of the present invention. The constant current controlling module 30 has a peak current value fixing unit 301, a discharge time detection unit 303, a switching period regulation unit 305, and a reference voltage generation unit 307.

The voltage waveform signal Vp captured by the auxiliary coil 27 may be fed back to the reference voltage generation unit 307 through a feedback circuit 29, before a reference voltage Vcomp could be generated.

The peak current value fixing unit 301 is for staying the peak current value iₛ₍ₚₖ₎ of the secondary current Is at the second predetermined value, by staying the peak current value iₚ₍ₚₖ₎ of the current waveform signal Ip at the first predetermined value. The peak current value fixing unit 301 is configured to receive a partial voltage of the reference voltage Vcomp and the current waveform signal Ip. When the value of the current waveform signal Ip is larger than that of the partial voltage of the reference voltage Vcomp, the peak current value fixing unit 301 may then send a signal to the control logic circuit 309. And the control logic circuit would generate a control signal Sc for turning off the switching unit 23, in order to stay the peak current value iₚ₍ₚₖ₎ of the current waveform signal Ip at the first predetermined value.

The discharge time detection unit 303 receives the voltage waveform signal Vp, and calculates a voltage value V_{T} that is positively proportional to the discharge time t_{D}, according to the voltage waveform signal Vp. And then the discharge time detection unit 303 may send the voltage value V_{T} to the switching period regulation unit 305, for adjusting the switching period t_{S}. In this embodiment, the switching period regulation unit 305 generates the signal to the control logic circuit 309 before the generation of the control signal Sc on basis of the charging and discharging of a built-in capacitor 3051.

The switching period regulation unit 305 has a switching component 3052, 3053, and 3054, a turn-on time control unit 3055, a cut-off time control unit 3056, and a cut-off time regulation unit 3057.

Before the switching unit 23 is turned on, the turn-on time control unit 3055 turns on the switching component 3052 while the cut-off time control unit 3056 turns off the switching component 3053. In doing so, a power source of the turn-on time control unit 3055 may charge the built-in capacitor 3051, for outputting a signal of a “high” voltage level to the control logic circuit 309. And the control logic circuit 309, which in turn sends the control signal Sc to the switching unit 23 for turning it on.

On the other hand, before the switching unit 23 is turned off, the turn-on time control unit 3055 turns off the switching component 3052 while the cut-off time control unit 3056 turns on the switching component 3053. Consequently, the built-in capacitor 3051 is discharged, for generating signal of a “low” voltage level to the control logic circuit 309, which in turn may generate the control signal Sc for turning off the switching unit 23.

Briefly speaking, when the built-in capacitor 3051 is in the charging mode, the control logic circuit 309 would send the control signal Sc for turning on the switching unit 23. And when the built-in capacitor 3051 is in the discharging mode, the control logic circuit would send the control signal for turning off the switching unit 23.

According to the method described above, the switching period t_{S} may be regulated by adjusting the duration of charging time and discharging time of the built-in capacitor 3051. In this embodiment, the cut-off time regulation unit 3057 is configured to receive the voltage value V_{T}, which may be positively proportional to the discharge time t_{D}, from the discharge time detection unit 303. In one implementation, when the voltage value V_{T} is larger than a predetermined threshold V_{T0} a built-in power source may be configured to turn on the switching component 3054, which may change a voltage level at a junction between the switching components 3053 and 3054. As the result, the duration of the discharging time of the built-in capacitor 3051 may be changed. Thus, the switching period t_{S} of the switching unit 23 may be further regulated according to the variation of the discharge time t_{D} of the secondary current Is.

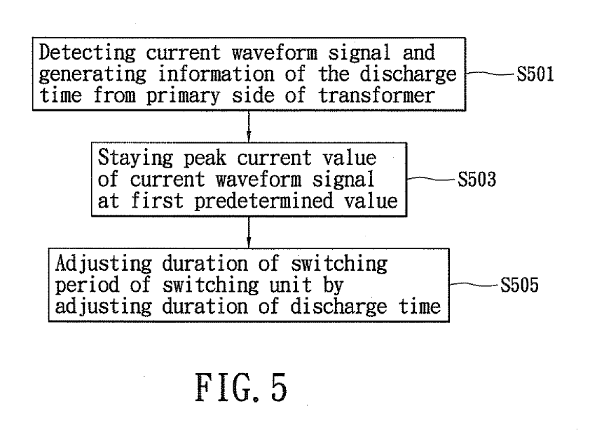

In conjunction with FIG. 2, FIG. 5 is a flow chart of the constant current controlling method according to one embodiment of the present invention. The method is for the power converter 20 with a transformer 21 and a switching unit 23. The switching unit 23 is coupled with the primary coil of the transformer 21. The method includes detecting the current waveform signal Ip and generating the information of the discharge time t_{D}, from the primary side of the transformer 21 (S501). Extracting the information of the discharge time t_{D} may be implemented by calculating the length of the duration during which the voltage waveform signal Vp stays at the peak value thereof.

The method further includes staying the peak current value iₚ₍ₚₖ₎ of the current waveform signal Ip, which is a current flows through the primary coil of the transformer 21, at the first predetermined value (S503). The method further includes adjusting the duration of the switching period t_{S} of the switching unit 23 by adjusting the duration of the discharge time t_{D}, (S505).

Because the peak current value iₚ₍ₚₖ₎ of the current flowing the primary coil at the primary side is proportional to the peak current value iₛ₍ₚₖ₎ of the inducted current at the secondary side, staying the peak current value iₚ₍ₚₖ₎ at the first predetermined value causes the peak current value iₛ₍ₚₖ₎ to stay at the second predetermined value. In order to ensure the output of a constant output current Io after the peak value of the secondary current Is currently remains at the second predetermined value, when the discharge time t_{D} of the second current varies the duration of the switching period t_{S} of the switching unit 23 may be adjusted to compensate such variation.

To sum up, the present invention implements the constant current controlling by staying the peak current value of the secondary current and regulating the switching period of the switching unit according to the information of the discharge time of the secondary current from the detected voltage waveform signal at the primary side and the detected current waveform signal at the primary side. And because the current waveform signal and the voltage waveform signal is obtained from the primary side of the transformer, the operational amplifiers, the current sensor, and the optical coupler may not be necessary at the secondary side of the transformer, minimizing the complexity and reducing the manufacturing cost and the size of the power converter.

Some modifications of these examples, as well as other possibilities will, on reading or having read this description, or having comprehended these examples, will occur to those skilled in the art. Such modifications and variations are comprehended within this invention as described here and claimed below. The description above illustrates only a relative few specific embodiments and examples of the invention. The invention, indeed, does include various modifications and variations made to the structures and operations described herein, which still fall within the scope of the invention as defined in the following claims.

What is claimed is:

1. A constant current controlling system, comprising:
a power converter having a transformer and a switching unit coupled with a primary coil of the transformer;
a constant current controlling module coupled with the transformer and the switching unit, for generating a control signal in order to control a duration of a switching period of the switching unit according to an information of a discharge time and a current waveform signal, wherein the discharge time and the current waveform signal are received from a primary side of the transformer, the constant current controlling module including:
a peak current value fixing unit coupled with the transformer and the switching unit, for fixing a peak current value of the current waveform signal flowing through the primary coil of the transformer;
a discharge time detection unit coupled with the transformer, for generating the information of the discharge time; and
a switching period regulation unit coupled with the switching unit, for generating the control signal according to the information of the discharge time.

2. The system as in claim 1, wherein the peak current value fixing unit generates the control signal for turning off the switching unit when the peak current value of the current waveform signal reaches a first predetermined value.

3. A constant current controlling module, for a power converter having a transformer and a switching unit coupled with a primary coil of the transformer, comprising:
a peak current value fixing unit coupled with the transformer and the switching unit, for receiving a current waveform signal from a primary side of the transformer, and staying a peak current value of the current waveform signal flowing through the primary coil of the transformer at a first predetermined value;
a discharge time detection unit coupled with the transformer, for generating an information of a discharge time; and
a switching period regulation unit coupled with the switching unit, for generating a control signal according to the information of the discharge time, in order to regulate a duration of a switching period of the switching unit.

4. The module as in claim 3, wherein the peak current value fixing unit generates the control signal for turning off the switching unit when the peak current value of the current waveform signal reaches the first predetermined value.

5. The module as in claim 3, wherein the information of the discharge time is generated according to a voltage waveform signal captured by an auxiliary coil winded at the primary side of the transformer.

6. The module as in claim 3, wherein the switching period regulation unit regulates the duration of the switching period by adjusting a duration of a cut-off time of the switching unit.

7. A constant current controlling method, for a power converter having a transformer and a switching unit coupled with a primary coil of the transformer, comprising:
receiving a current waveform signal flowing through the primary coil of the transformer and generating an information of a discharge time from a primary side of the transformer;
staying a peak current value of the current waveform signal at a first predetermined value; and
adjusting a duration of a switching period of the switching unit according to the information of the discharge time.

8. The method as in claim 7, further comprising generating the information of the discharge time by receiving a voltage waveform signal captured by an auxiliary coil winded at the primary side of the transformer.

9. The method as in claim 7, wherein staying the peak current value of the current waveform signal at the first predetermined value includes turning off the switching unit when the peak current value of the current waveform signal reaches the first predetermined value.

10. The method as in claim 7, wherein adjusting the duration of the switching period includes adjusting a duration of a cut-off time of the switching unit.
